(19) United States
(12) Patent Application Publication
(10) Pub. No.: US 2016/0307197 A1
(43) Pub. Date: Oct. 20, 2016

(54) SYSTEM AND METHOD OF GENERATING AND VALIDATING A UNIQUE TRANSACTION IDENTIFIER

(71) Applicant: Solutio LLC, Marlboro, NJ (US)

(72) Inventors: Zachary Roeill, Marlboro, NJ (US); Vincent Framularo, Marlboro, NJ (US); Nichole Framularo, Bridgeport, CT (US)

(73) Assignee: Solutio LLC, Marlboro, NJ (US)

(21) Appl. No.: 15/189,283

(22) Filed: Jun. 22, 2016

Related U.S. Application Data
(63) Continuation-in-part of application No. 14/156,425, filed on Jan. 15, 2014.

(51) Int. Cl. G06Q 20/40

(52) U.S. Cl. CPC G06Q 20/401

(57) ABSTRACT

A unique transaction identifier governor generates and/or validates a unique trade identifier based on a set of pre-defined rules. The identifier is made up of multiple components, each component being generated using a linear construct, a rule-based hierarchies construct, or an algorithmic construct. Additionally, the governor enables the user to implement a customized construct for generating strings of Arabic numerals, letters, or any combination thereof as separate identifier components. Once an identifier is created and/or validated, the governor updates its database to include the identifier, and components therefor, in a comprehensive list of all previously generated identifiers. Thus, the governor is able to validate uniqueness of identifiers by cross-checking each generated component or identifier against the previously generated identifiers, and components therefor, stored within the governor's database(s). Through the validation process, the governor guarantees global uniqueness of the transaction identifier, i.e., across all clients, jurisdictions, and products.

### CROSS-REFERENCE TO RELATED APPLICATION(S)

The present application is a continuation in part of U.S. patent application Ser. No. 14/156,425 filed on Jan. 15, 2014, entitled “Global Unique Transaction Identifier (UTI) Generator” the entire disclosure of which is incorporated by reference herein.

### BACKGROUND OF THE INVENTION

1. Field of Invention

The present invention relates to the field of pre-generating, generating, validating, and communicating uniqueness of transaction identifiers.

2. Description of Related Art

Unique transaction identifier generation and processing should take place at the earliest point in the lifecycle process of a transaction. Unique transaction identifier configurations are necessary to meet the requirements of multiple regulatory regimes and their complex transaction identification, processing and reporting requirements. Workflows are continuously evolving as rules are finalized in many regimes. Currently, all processes surrounding the UTI are decentralized down to individual market participants. This means that each individual market participant is personally responsible for ensuring that their transactions meet regulatory requirements. As a necessity for ensuring increased transaction transparency dictated by various regulatory regimes around the world, each transaction must be assigned a transaction identifier that is unique. The uniqueness of transaction identifiers ensures that each transaction can be individually identified and reported to regulators, who then seek to enforce regulations over transactions. Regulations cannot be fully enforced if individual transactions are unable to be accurately identified. Further complicating the issue, each regulatory regime has implemented disparate regulations regarding the UTI process. As such, a number of inconsistencies arise when market participants from different regulatory regimes engage in a transaction, in addition to when market participants within the same regulatory regime engage in a transaction. Regulatory regimes have instituted complex till Generation Hierarchies that aim to resolve these issues. However, they fall short of addressing the heart of the problem, which is: how can Party A and Party B both be entirely sure that the UTI assigned to their transaction has not been used before, and how can they be sure that their counterparty has met all the regulatory reporting requirements for their side of the transaction? Failing to meet transaction reporting requirements has dire implications that can lead to transaction reconciliation problems, fines, and other regulatory consequences. Understanding this, it becomes apparent that the reliance on manual processes, such as email or phone calls, in tandem with individual implementation of generation hierarchies, is detrimental to regulatory regimes and their capabilities to accurately and efficiently enforce their specific regulations.

Based on the foregoing, there is a need in the art for a system for generating and/or validating the uniqueness of a transaction identifier that ensures regulations can be accurately and efficiently enforced, while simultaneously removing the burden of regulatory enforcement from individual market participants.

### SUMMARY OF THE INVENTION

The unique transaction identifier (“UTI” or the “identifier”) is a transaction level identifier that is associated with a transaction. A UTI can persist throughout the entire life of that transaction, or it may encounter a life-cycle event that requires the assignment of a new UTI. This process supports the compliance reliability within, but not limited to, the derivatives, e.g., OTC and ETD, markets. The UTI generation and/or validation processes aims to enhance simple and abstract transactional identification and anonymity, mitigate against risk, and harmonize cross-jurisdictional transactional data. An electronic unique transaction identifier governor (“UTIG” or the “governor”) functions as a non-governmental, third-party that ensures a seamless experience for the UTI generation and/or validation process across multiple regulatory regimes, financial products, and a conglomeration of other UTI creators/consumers. UTIG strives to guarantee uniqueness of transaction identifiers through all configurations and workflows of all jurisdictions, while also ensuring that the transaction meets the reporting requirements set forth by regulatory regimes.

A computer-implemented method for generating a globally unique transaction identifier includes the steps of: i.) a requesting party submitting data to a transaction identifier governor that has a central processing unit and a non-transitory computer readable medium with software instructions stored therein; ii.) the requesting party requesting a transaction identifier for one or more transactions from the transaction identifier governor; iii.) the transaction identifier governor extracting the data from one or more central processing unit registers; iv.) the transaction identifier governor generating the transaction identifier based on the data; v.) the transaction identifier governor validating uniqueness of the transaction identifier; and vi.) the transaction identifier governor transmitting the transaction identifier to the requesting party.

A computer-implemented method for validating global uniqueness of a pre-generated transaction identifier includes the steps of: i.) a requesting party submitting a pre-generated transaction identifier to a transaction identifier governor that has a central processing unit and a non-transitory computer readable medium having software instructions stored therein; ii.) the transaction identifier governor validating uniqueness of the pre-generated transaction identifier. If the pre-generated transaction identifier is unique, the transaction identifier governor confirms and transmits validation to the submitting party. If the pre-generated transaction identifier is not unique, the method continues to the steps of: iii.) the transaction identifier governor extracting party-supplied data from one or more central processing unit registers; iv.) the transaction identifier governor generating a transaction identifier based on the data; v.) the transaction identifier governor validating uniqueness of the transaction identifier; and vi.) the transaction identifier governor transmitting the validated transaction identifier to the requesting party.

In an embodiment, the method of validating global uniqueness of a pre-generated transaction identifier also includes the step of the transaction identifier governor referencing a distributed ledger to validate uniqueness of the transaction identifier. Alternatively, the transaction identifier governor can be configured to reference a centralized database to validate uniqueness of the transaction identifier. When using a distributed ledger, all communications to and from the transaction identifier governor are encrypted. In an embodiment, a multi-tiered encryption model is used in which a transaction data block of each party is individually encrypted, a transaction data block of each transaction is individually encrypted, and a chain of data blocks is encrypted. Before decrypting the data pertaining to a party of a transaction, the chain of data blocks must be decrypted, followed by a decryption of the transaction's transaction data block, followed by a decryption of the party's transaction data block.

In an embodiment in either the method of generating, pre-generating, and or validating a transaction identifier, the data is unique to the parties and the transactions. For example, the data may include a regulatory jurisdiction of the parties, a regulatory jurisdiction of the transactions, a type of product involved in the transactions, and/or a transactional position of the submitting party. The transaction identifier governor uses the data in generating a plurality of transaction identifier components and combines the components to generate the transaction identifier. In an embodiment, the data includes customized configurations for generating sequential alphanumeric strings.

In an embodiment, at least one of the transaction identifier components is derived by the transaction identifier governor using a rule-based construct that follows an identifier generation hierarchy and set of rules. The transaction identifier governor determines the generation hierarchy to be used based on the jurisdiction of the parties and transactions involved.

In an embodiment at least one of the transaction identifier components are derived by the transaction identifier governor using an algorithmic-based construct method comprising the steps of: i.) the transaction identifier governor generating a sequential transaction number when the request is received, based on the configuration specified by the parties; ii.) the transaction identifier governor applying a base conversion to the sequential transaction number; iii.) the transaction identifier governor adjusting the converted sequential transaction number to a length specified by the transaction identifier governor; and iv.) the transaction identifier governor validating uniqueness of the converted sequential transaction number. If the converted sequential transaction number already exists, the step of generating the transaction identifier is repeated until a unique transaction number is generated and validated. In an embodiment, the base to convert is randomly assigned by the transaction identifier governor. In another embodiment, the base to convert is pre-set by the transaction identifier governor.

In an embodiment, a transmission to and/or from one or more parties includes the UTI. In yet another embodiment, the transmission includes a UTI for one or more lifecycle events of a transaction including but not limited to new transactions, partial terminations, novations, terminations, corporate actions, exercises, etc.

In an embodiment, the UTI is derived using a unique prefix, a parameter of the transaction, a geographical indicator, a random, algorithmic, or sequential identifier, or any combination thereof, with or without the identifier, such as an ISIN, of one or more accounts.

In an embodiment, a UTI generation request is received from one of the transaction parties. The request can either: 1) ask for a UTI(s) to be pre-generated and validated for future use, 2) ask for a UTI(s) to be generated and validated for immediate use, or 3) submit a UTI(s) to validate uniqueness for future or immediate use.

In an embodiment, UTIG may receive a request to pre-generate a number of UTIs, specified by the requesting party. UTIG may then generate the number of requested UTIs and communicate them to the requesting party. These pre-generated UTIs can then be stored by the requesting party or by UTIG for future use.

When transmitting the request, the requesting party can submit data unique to the party(s) of the transaction(s) and/or the transaction(s) involved. During the UTI generation process, UTIG extracts the data from its CPU registers (or some other memory location/storage media) and uses that data to generate one or more identifier components that will be used to create the UTI.

A method of using UTIG includes receiving a request representing one or more transactions between one or more parties, wherein the identifier of the transaction is unique among the plurality of transactions of one or more parties; deriving a globally UTI, wherein each UTI in a plurality of UTIs is wherein the UTI is unique within one or more processing systems such that the UTI associated with the transaction is unique among the plurality of UTIs each associated with one transaction among the plurality of transactions conducted with the plurality of parties; forming one or more transmissions to one or more parties, wherein the transmission(s) include(s) the associated transaction and the relevant UTI; receiving either an assignment, matching or enrichment request from one or more parties, wherein the response includes the UTI; and receiving a request to pre-generate/generate and/or validate one or more UTIs for one or more transactions so that the final corresponding transaction can be forwarded to one or more parties, wherein the response includes the UTI.

In an embodiment, the method includes the additional step of receiving a transmission that includes a request to pre-generate/generate and/or validate one or more UTIs for one or more transactions. This will be available for individual and bulk UTI pre-generation/generation/validation requests. In another embodiment, the transmission includes a request to pre-generate/generate, and/or validate one or more UTIs for one or more transactions for each respective transaction so that the final corresponding transaction can be forwarded to one or more parties, wherein the transmission includes the UTI.

In an embodiment, a request is received from one or more parties to one or more transactions, wherein the request is formed in a separate transmission including the UTI, wherein the UTI is used to match the request with the transaction. In another embodiment, the request is formed in a separate transmission including one or more different UTIs for the same transaction or plurality of transactions, wherein the parties have the ability to determine which UTI becomes associated with and assigned to the respective transactions. In yet another embodiment, the request is formed in a separate transmission including one or more different UTIs for the same transaction or plurality of transactions, wherein UTIG has the ability to determine (a) that the UTI is unique among all UTIs and (b) which UTI becomes associated with and assigned to the respective transactions.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a flowchart depicting a possible variation of a client UTI active-request process, according to an embodiment of the present invention; and

FIG. 2 is a flowchart depicting a possible variation of a client-generated UTI passive-request process, according to an embodiment of the present invention.

### DETAILED DESCRIPTION OF PREFERRED EMBODIMENTS

UTIG has a central processing unit and a non-transitory computer readable medium storing computer readable code capable of being executed by the processing unit. UTIG generates, receives, assigns, matches, and/or distributes one or more UTIs for one or more transactions by and between one or more parties, such that the identification of a transaction is unique among the plurality of all transactions and all parties to the transactions. Each UTI in a plurality of UTIs can be derived without using a corresponding identifier, such as an account identifier, thus ensuring anonymity of the parties. Once derived, the UTI is associated with the transaction. Thus, not only is the identifier unique within the processing system, but also maintains uniqueness among the plurality of UTIs each associated with one transaction among the plurality of transactions conducted with the plurality of parties.

The UTI generation process begins by generating a plurality of character strings of Arabic numerals, letters, or any combination thereof. The character strings are subsequently combined to form the UTI. In an embodiment, the character string is based on information specific to the party requesting the UTI. The generation process follows existing rules set forth in pre-set UTI generation hierarchies for determining the UTI structure. UTIG determines which generation hierarchy it follows based on, for example, the jurisdictional requirements of the parties involved with the transaction.

UTIG creates a unique trade number or identifier based on a set of pre-defined rules. The need is driven by multiple regimes' specifications, and maintaining uniqueness in light thereof. UTIG generates unique components based upon user-specified constructs. The components are individually generated based upon one of three distinct constructs, including i.) a linear construct, ii.) a rule-based hierarchies construct, and an algorithmic construct. As such, each component of a particular UTI can be generated using either the same or a different construct as used in generating the remaining component(s) of the UTI. Additionally, UTIG enables the user to implement a customized construct for generating strings of Arabic numerals, letters, or any combination thereof, as separate UTI components used within the final UTI construct.

The linear based component construct follows a simple incremental increase that is repeated upon the generation of a new UTI component designated as a linear component. The assigned number will increase by a set increment with every subsequent UTI generated requiring that designated linear component within its construct, For example, if the first assigned number was “0001,” the second assigned number would be “0002,” and the fifteenth assigned would be “0015.”

The rule based component construct follows a set of prescribed generation rules to ensure standardized UTI component generation. Using information specific to the transaction and requesting party, UTIG can produce UTI components by following prescribed hierarchies and rule-sets. For example, a UTI component may be generated based on the requesting party's transactional position as buyer or seller. As another example, a UTI component may be generated based on the geographical location of a party to the transaction. As a further example, a UTI component may be generated based on the economic size of one of the transaction parties, e.g. corporations or individuals. And, as a final example, a UTI component may be generated based on the primary product type of the transaction,

The algorithmic-based component construct would be used to generate UTI components that are unique and have not been used before. As an example, a UTI component can be generated algorithmically using the following steps: 1) A linear, sequential transaction number is recorded in UTIG systems as a generation request is received using the linear method detailed hereinabove, e.g. the first request can be assigned the transaction number “10001” and that number can be set to increase at a set increment with every new generation request; 2) the recorded transaction number is then forced through abase conversion (the base to convert to can be randomly selected or pre-set by UTIG), e.g. “10001” converted from base 10 to base 19 is 18d7; 3) the component is adjusted to meet length requirements set by UTI construct; 4) UTIG then validates that the base-converted component has not been previously used/recorded within UTIG systems, if it fails validation of uniqueness, a new linear, sequential transaction number is generated as if for a new transaction and is then put through the base conversion, tested for validation and repeated until validation is passed; 5) upon validation, the base converted component is used in the final UTI construct (made up of multiple UTI components), and the final version is communicated to the requesting party.

The construct combinations will allow UTIG users to build and implement modular UTI constructs. The modular UTI construct is made of two or more UTI components. The modular UTI construct provides UTIG with the ability to reorder, alter, eliminate, or add different UTI components. As discussed above, UTI components can be derived linearly, through rule-based hierarchies, or algorithmically. The components making up the construct can be reordered or altered as indicated by the hierarchy or rules applied to UTIG.

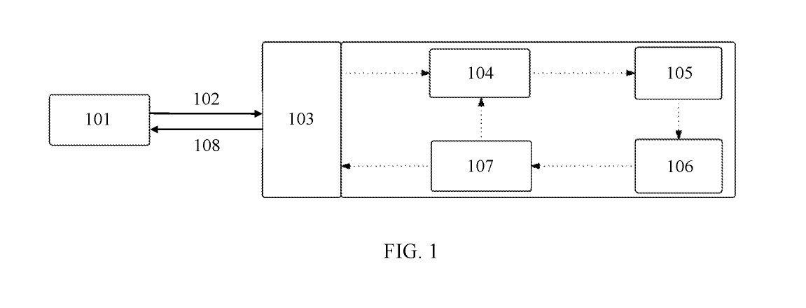

FIG. 1 depicts a possible variation of the client UTI active-request process. Included are the steps of 1) responding to a UTI pre-generation or generation request(s) and submitted data points; 2) generating UTI components using either linear, rule-based, or algorithmic techniques, in constructing the UTI(s); 3) validating the uniqueness of individual UTI components and/or the finalized UTI(s); and 4) transmitting the final UTI(s) back to the requesting party.

At step 102, requesting party 101 transmits an active-request for the pre-generation or generation of one or more UTI(s) for one or more transactions to UTIG 103. In an embodiment, as part of the active-request, the party 101 submits data unique to the party 101 and/or the transaction(s) involved, e.g., their regulatory jurisdiction or product type. In an embodiment, the party 101 is a recognized partner service/organization, e.g., a repository for managing pre-generated UTI(s). In another embodiment, the party is a recognized UTIG user, e.g., a direct consumer of the UTI(s). At step 104, UTIG 103 assigns an incremental ID internally to the UTI(s) contained within the active-request transmitted at step 102 or assembled by UTIG at step 106. At step 105, UTIG 103 extracts the submitted data from its CPU registers, or other digital memory location or storage media, and uses it to generate individual UTI construct components using prescribed rule-based or algorithmic methods. At step 106, UTIG 103 assembles the UTI(s) using the construct components from step 105. At step 107, UTIG 103 performs validation on the UTI(s) assembled at step 106. If validation process returns a failure, the process returns to step 104. The request is processed in this manner until the validation of a replacement UTI(s) is approved at step 107. Upon approval, the UTI(s) assembled at step 106 is then recorded by UTIG 103. Finally, at step 108, the return transmission containing the final pre-generated/generated UTI(s) is transmitted from UTIG 103 to the party 101.

If a user prefers to generate and submit their own UTI, they can do so without using the generation module of UTIG. In the event that a generated or submitted UTI fails to be properly validated, i.e., UTIG determines that it is not unique, UTIG will automatically generate a replacement UTI.

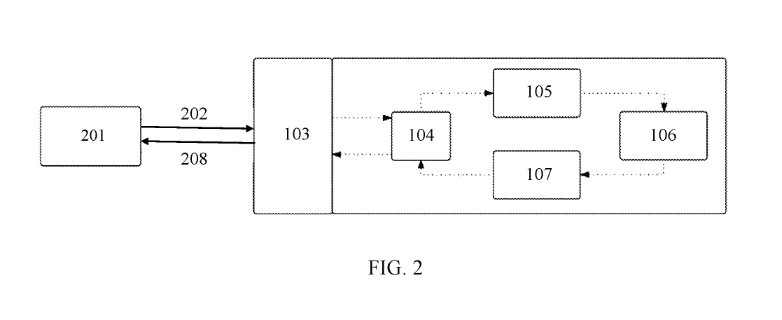

FIG. 2 depicts a possible variation of the client-generated UTI passive-request process. Included are the steps of 1) responding to a client-generated UTI(s) validation request and submitted data points; 2) validating the uniqueness of the submitted UTI(s) against existing UTI database; and determining the course of action based on the validation outcome(s); 3) confirming and transmitting the UTI(s) validation confirmation(s) back to the submitting party indicating the UTI(s) has been validated; and 4) generating replacement UTI(s) and transmitting back to the submitting party indicating the UTI has failed validation and has been replaced.

At step 202, submitting party 201 transmits a passive-request for one or more client-generated UTI(s) to be validated by UTIG 203 for immediate or future use. Along with the passive-request, the party 201 can submit data unique to the submitting party and/or the transaction(s) involved, e.g. their regulatory jurisdiction or product type. In an embodiment, the party 201 is a recognized partner service/organization, e.g., a repository for managing pre-generated UTI(s). In another embodiment, the party is a recognized UTIG user, e.g., a direct consumer of the UTI(s). At step 204, UTIG 203 performs validation on the UTI submitted within the passive-request by the party 201. If validation succeeds, the passive-request for validation is confirmed and transmitted by UTIG 203 via electronic transmission 208 to submitting party 201. If validation fails, i.e. UTI already exists, the passive-request becomes an active-request, which is then passed by UTIG 203 from step 204 to step 205. At step 205, the request is assigned an incremental ID internally. At step 206, UTIG 203 extracts the submitted data from its CPU registers, or some other digital memory location or storage media, and uses it to generate individual UTI construct components using prescribed rule-based or algorithmic methods. At step 207, UTIG 203 assembles the UTI(s) using the construct components from step 206. The finalized UTI(s) are passed back to step 204, where the validation process is repeated until a UTI is identified.

Once a UTI is created and/or validated, UTIG updates its database to include the UTI, as well as each individual UTI component therefor, in a comprehensive list of all previously generated UTIs. Thus, UTIG is able to validate uniqueness of UTIs by cross-checking each generated component or full UTI against the previously generated UTIs, and components therefor, stored within UTIG's electronic database(s). Through the validation process, UTIG guarantees global uniqueness of the transaction identifier, i.e., across all clients, jurisdictions, and products. In an embodiment, UTIG uses an electronic distributed ledger to maintain its data, thus eliminating the industry's single-point-of-failure concerns regarding UTI generation by disallowing any party to manipulate the data without being noticed. In an alternative embodiment, UTIG uses an electronic centralized database to maintain its data. If using a distributed ledger, UTIG validates the UTI is unique by cross-checking the UTI to the distributed ledger. Alternatively, if using a centralized database, UTIG validates the UTI is unique by querying one or more electronic databases within UTIG.

Once uniqueness has been verified, UTIG guarantees communication of UTIs to all relevant parties in near real-time as the UTI is generated and/or validated. UTI communication can be configured to mirror current transaction reporting standards (such as single-sided or dual-sided report) or, alternatively, it can be customized to meet the needs of an ever-changing regulatory environment. As an example, if configured to mirror dual-sided reporting regulations, UTIG would i.) receive transaction data from both transaction parties, ii.) generate the UTI if not provided (or validate the UTI' s uniqueness if provided) using the existing UTI generation hierarchies to determine which party has the right to create and submit a UTI, and finally, iii.) communicate the UTI directly to both transaction parties. As an alternative example, if configured to mirror single-sided reporting regulations, UTIG would i.) receive transaction data from the dominant transaction party, determined by the existing UTI generation hierarchies, ii.) generate the transaction UTI if not provided (or validate the UTI' s uniqueness if provided), and finally, iii.) communicate the UTI directly to the requesting party. The requesting party then communicates the UTI to their transaction counterpart.

All communications to and from UTIG are encrypted, and all individual data points are encrypted, regardless of the configuration used. Further, if a distributed ledger is used, each half of a transaction's data block is individually encrypted, each full transaction's data block is individually encrypted, and each chain of data blocks is encrypted, thus ensuring a multi-level approach to transaction security. Before decrypting the data pertaining to a specific party of a transaction, the data chain must be decrypted, followed by a decryption of the transaction's specific block, and then the decryption of the specific half of the block pertaining to the party in question.

UTIG's configuration can be modified at any time. For example, the UTI generation hierarchies used to determine the structure of the UTI can be swapped in and/or out as regulations and industry needs evolve. Additionally, UTIG can assign a different generation hierarchy to each regulatory jurisdiction to ensure that the regulations of each jurisdiction are individually adhered to. UTIG's communication configuration can also be customized as needed in regards to the regulatory requirements imposed by transaction parties' governing regimes. This feature would be especially beneficial, for example, in a transaction between a party located in the United States (regulated by American laws) and a counterparty located in the European Union (regulated European laws).

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A computer-implemented method for generating a globally unique transaction identifier comprising the steps of:
a. a requesting party submitting data to a transaction identifier governor, the transaction identifier governor having a central processing unit and a non-transitory computer readable medium having software instructions stored therein;
b. the requesting party requesting a transaction identifier for one or more transactions from the transaction identifier governor;
c. the transaction identifier governor extracting the data from one or more central processing unit registers;
d. the transaction identifier governor generating the transaction identifier based on the data;
e. the transaction identifier governor validating uniqueness of the transaction identifier; and
f. the transaction identifier governor transmitting the transaction identifier to the requesting party.

2. The method of claim 1, wherein the data is unique to the requesting party and the one or more transactions, wherein the transaction identifier governor uses the data in generating a plurality of transaction identifier components, wherein the transaction identifier governor combines the transaction identifier components to generate the transaction identifier.

3. The method of claim 2, wherein the data comprises customized configurations for generating sequential alphanumeric strings.

4. The method of claim 2, wherein the data is selected from the group consisting of a regulatory jurisdiction of the requesting party, a regulatory jurisdiction of the one or more transactions, a type of product involved in the one or more transactions, and a transactional position of the requesting party.

5. The method of claim 2, wherein at least one of the transaction identifier components is derived by the transaction identifier governor using a rule-based construct that follows an identifier generation hierarchy and set of rules, wherein the transaction identifier governor determines the generation hierarchy to be used based on the jurisdiction of the requesting party and one or more transactions.

6. The method of claim 1, wherein at least one of the transaction identifier components are derived by the transaction identifier governor using an algorithmic-based construct method comprising the steps of:
a. the transaction identifier governor generating a sequential transaction number when the request is received, based on the configuration specified by the requesting party;
b. the transaction identifier governor applying a base conversion to the sequential transaction number;
c. the transaction identifier governor adjusting the converted sequential transaction number to a length specified by the transaction identifier governor; and
d. the transaction identifier governor validating uniqueness of the converted sequential transaction number,
wherein if the converted sequential transaction number already exists, the step of generating the transaction identifier is repeated until a unique transaction number is generated and validated.

7. The method of claim 6, wherein a base to convert is randomly assigned by the transaction identifier governor.

8. The method of claim 6, wherein a base to convert is pre-set by the transaction identifier governor.

9. The method of claim 1, further comprising the step of the transaction identifier governor referencing a distributed ledger to validate uniqueness of the transaction identifier, wherein communications to and from the transaction identifier governor are encrypted, wherein a transaction data block of each party to the one or more transactions is individually encrypted, wherein a transaction data block of each transaction of the one or more transactions is individually encrypted, and wherein a chain of data blocks is encrypted, wherein before decrypting the data pertaining to a party of the one or more transactions, the chain of data blocks must be decrypted, followed by a decryption of the transaction's transaction data block, followed by a decryption of the party's transaction data block.

10. The method of claim 1, wherein the transaction identifier governor references a centralized database to validate uniqueness of the transaction identifier.

11. A computer-implemented method for validating global uniqueness of a pre-generated transaction identifier comprising the steps of:
a. a party submitting a pre-generated transaction identifier to a transaction identifier governor, the transaction identifier governor having a central processing unit and a non-transitory computer readable medium having software instructions stored therein;
b. the transaction identifier governor validating uniqueness of the pre-generated transaction identifier, wherein if the pre-generated transaction identifier is unique, the transaction identifier governor confirms and transmits validation to the submitting party, and wherein if the pre-generated transaction identifier is not unique, the method further comprises the steps of:
c. the transaction identifier governor extracting data from one or more central processing unit registers, said data supplied by the submitting party;
d. the transaction identifier governor generating a transaction identifier based on the data;
e. the transaction identifier governor validating uniqueness of the transaction identifier; and
f. the transaction identifier governor transmitting the validated transaction identifier to the requesting party.

12. The method of claim 11, wherein the data is unique to the submitting party and one or more transactions, wherein the transaction identifier governor uses the data in generating a plurality of transaction identifier components, wherein the transaction identifier governor combines the transaction identifier components to generate the transaction identifier.

13. The method of claim 12, wherein the data comprises customized configurations for generating sequential alphanumeric strings.

14. The method of claim 12, wherein the data is selected from the group consisting of a regulatory jurisdiction of the submitting party, a regulatory jurisdiction of the one or more transactions, a type of product involved in the one or more transactions, and a transactional position of the submitting party.

15. The method of claim 12, wherein at least one of the transaction identifier components is derived by the transaction identifier governor using a rule-based construct that follows an identifier generation hierarchy and set of rules, wherein the transaction identifier governor determines the generation hierarchy to be used based on the jurisdiction of the submitting party and the one or more transactions.

16. The method of claim 12, wherein at least one of the transaction identifier components are derived by the transaction identifier governor using an algorithmic-based construct method comprising the steps of:
a. the transaction identifier governor generating a sequential transaction number when the request is received, based on the configuration specified by the submitting party;
b. the transaction identifier governor applying a base conversion to the sequential transaction number;
c. the transaction identifier governor adjusting the converted sequential transaction number to a length specified by the transaction identifier governor; and
d. the transaction identifier governor validating uniqueness of the converted sequential transaction number,
wherein if the converted sequential transaction number already exists, the step of generating the transaction identifier is repeated until a unique transaction number is generated and validated.

17. The method of claim 16, wherein a base to convert is randomly assigned by the transaction identifier governor.

18. The method of claim 16, wherein a base to convert is pre-set by the transaction identifier governor.

19. The method of claim 11, further comprising the step of the transaction identifier governor referencing a distributed ledger to validate uniqueness of the transaction identifier, wherein communications to and from the transaction identifier governor are encrypted, wherein a transaction data block of each party to one or more transactions is individually encrypted, wherein a transaction data block of each transaction of the one or more transactions is individually encrypted, and wherein a chain of data blocks is encrypted, wherein before decrypting the data pertaining to a party of the one or more transactions, the chain of data blocks must be decrypted, followed by a decryption of the transaction's transaction data block, followed by a decryption of the party's transaction data block.

20. The method of claim 11, wherein the transaction identifier governor references a centralized database to validate uniqueness of the transaction identifier.
